(19) United States
(12) Patent Application Publication
(10) Pub. No.: US 2011/0283824 A1
(43) Pub. Date: Nov. 24, 2011

(54) Actuator

(76) Inventor: Krister Kumlin, Svanskog (SE)

(21) Appl. No.: 13/146,090

(22) PCT Filed: Feb. 1, 2010
(86) PCT No.: PCT/SE10/50104

§ 371 Date: Jul. 25, 2011

(30) Foreign Application Priority Data
Feb. 2, 2009 (SE) 0950034-9

(51) Int. Cl. F16H 25/20

(52) U.S. Cl. 74/89.24

(57) ABSTRACT

An actuator comprising a motor having a drive shaft, a spindle which is directly or indirectly driven by the drive shaft and which exhibits an axial recess being delimited by an internal limiting surface, said spindle comprising an internal thread arranged on the limiting surface, said thread having a predetermined axial extension, and a piston rod which is arranged in the recess to perform a translational movement relative to the spindle between a first end position and a second end position when the spindle is rotating, said end positions defining a length of stroke of the piston rod, said piston rod comprising a threaded portion which exhibits an external thread and has a predetermined axial extension, said external thread being adapted to interact with the internal thread of the spindle. According to the invention, the axial extension of the internal thread of the spindle is at least twice as long as the axial extension of the threaded portion of the piston rod.

The present invention relates to an actuator comprising:
a motor which comprises a rotatable drive shaft,
a spindle which is rotatably arranged to be driven directly or indirectly by the drive shaft of the motor and which exhibits an axial recess which is at least partially delimited by a substantially circularly cylindrical, internal limiting surface of the spindle, said spindle comprising an internal thread arranged on at least a part of said limiting surface, said thread having a predetermined axial extension, and
a piston rod which is arranged in the recess of the spindle to perform a translational movement in an axial direction relative to the spindle between a first end position and a second end position while the spindle is rotating, said end positions defining a length of stroke of the piston rod, said piston rod comprising a threaded portion which exhibits an external thread and has a predetermined axial extension, said external thread being adapted to interact with the internal thread of the spindle.

U.S. Pat. No. 7,340,974 B2 discloses an adjusting device intended to be used for adjusting a seat of a motor vehicle. The actuator comprises a spindle nut having an internal thread for driving a threaded rod, which has an external thread across its entire length. The spindle nut is driven to rotate via a worm gear. The threaded rod performs a transverse movement when the spindle nut rotates.

One disadvantage with this actuator is that the threads on the spindle are not protected, which makes it unsuitable for external mounting.

The purpose of the present invention is to achieve an actuator which solves this problem and which, furthermore, allows a small apparatus constant, i.e. small mounting dimensions in relation to its length of stroke.

The actuator according to the invention is characterized in that the axial extension of the internal thread of the spindle is at least twice as long as the axial extension of the threaded portion of the piston rod.

In the following, the invention will be described more closely with reference to the drawings, in which:

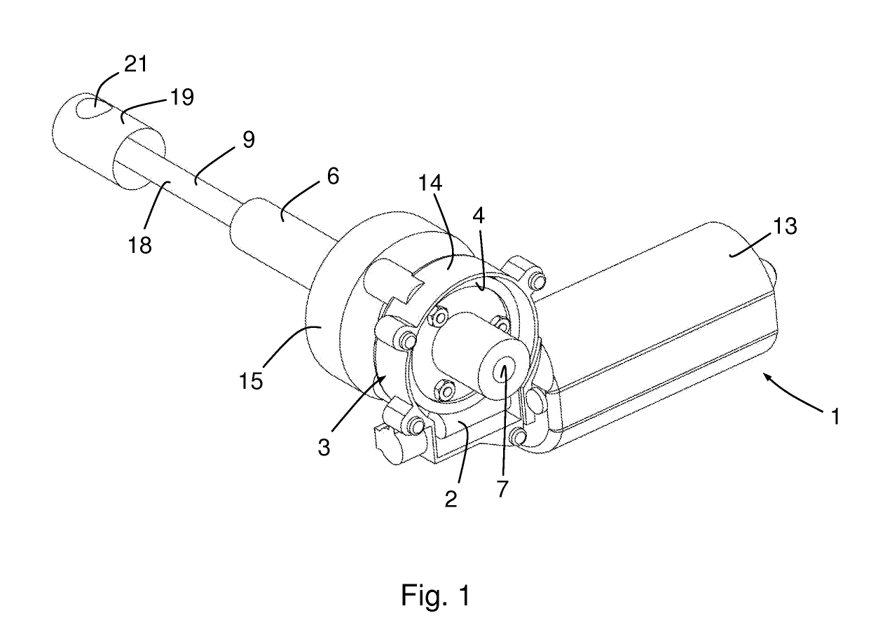

FIG. 1 shows an actuator according to one embodiment of the invention.

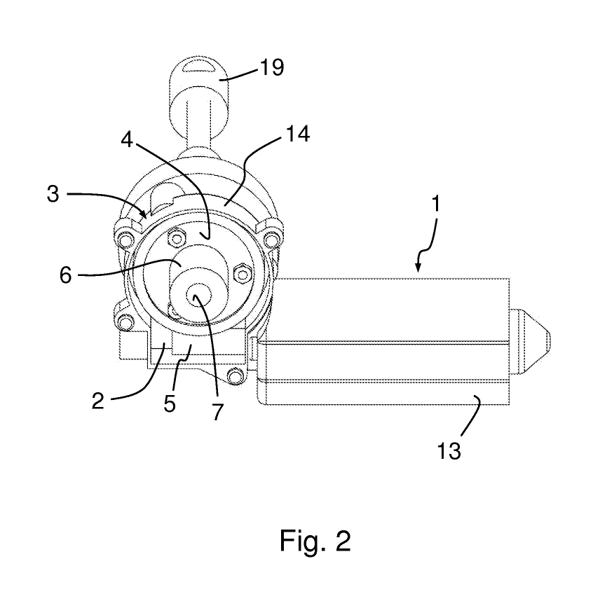

FIG. 2 shows a side view of the actuator of FIG. 1.

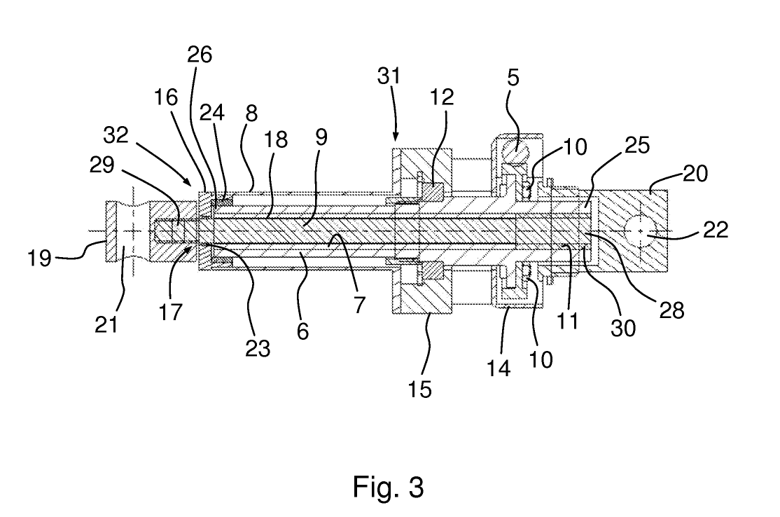

FIG. 3 shows a cross-section of the actuator of FIG. 1, wherein the piston rod of the actuator is in a first, inner end position.

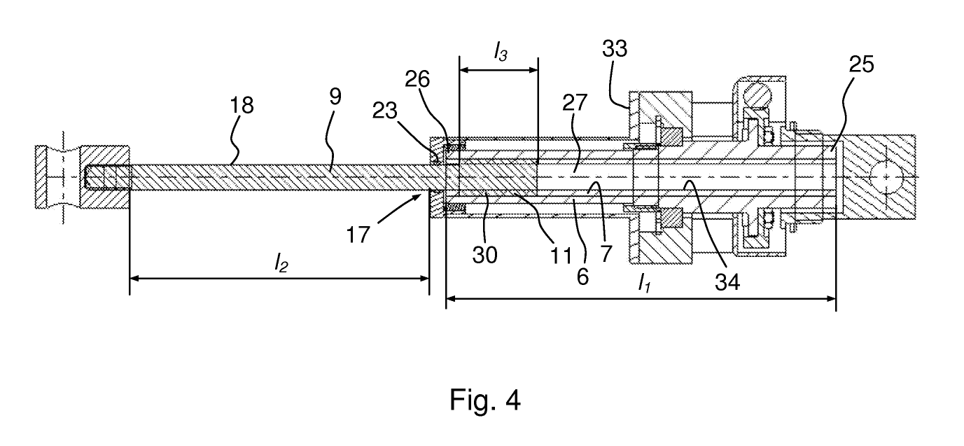

FIG. 4 shows a cross-section of the actuator of FIG. 1, wherein the piston rod of the actuator is in a second, outer end position.

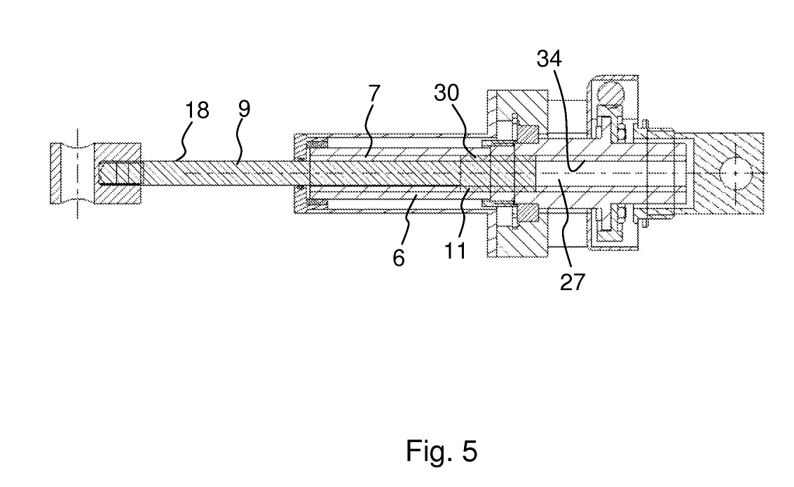

FIG. 5 shows a cross-section of the actuator of FIG. 1, wherein the piston rod is in a position between the first, inner end position and the second, outer end position.

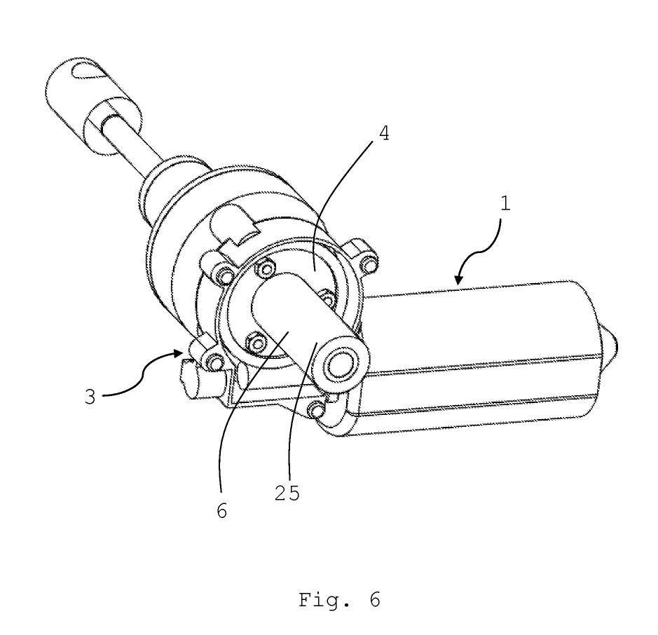

FIG. 6 shows a side view of the actuator of FIG. 1, wherein the worm wheel of the actuator is arranged at the middle of the spindle of the actuator.

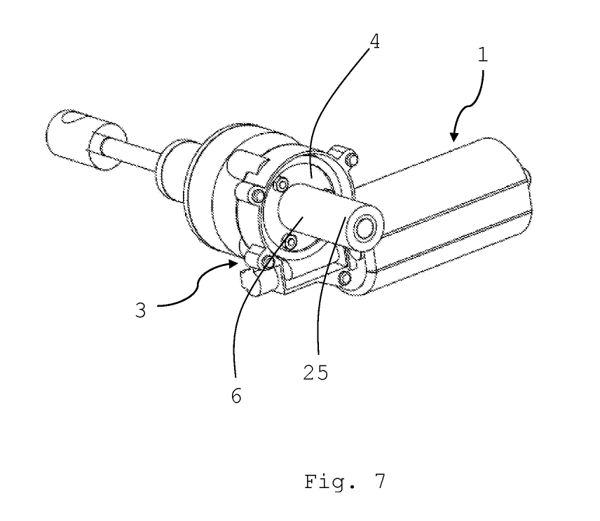

FIG. 7 shows another side view of the actuator of FIG. 1, wherein the worm wheel of the actuator is arranged at the middle of the spindle of the actuator.

FIGS. 1-5 show an actuator comprising a drive gear in the form of a motor 1, a worm gear 3, a tubular spindle 6 and a piston rod 9.

The motor 1 is preferably an electric, reversible DC motor which can have, for example, a rated voltage of 12V, 24V, 36V or 48V. The motor 1 comprises a rotatable drive shaft 2 and a motor housing 13.

The worm gear 3 comprises a worm wheel 4 and a worm 5 which is arranged on, or in, the drive shaft 2 of the motor. The worm wheel 4 cooperates with the worm 5 in such a way that the rotation of the worm 5 drives the worm wheel 4 to rotate. The worm gear 3 is surrounded by a gear housing 14.

The spindle 6 is elongated and extends between a first, inner end 25 and a second, outer end 26, and exhibits an axial recess 27 which is at least partially delimited by a substantially circularly cylindrical, internal limiting surface 34 of the spindle 6. In the shown exemplary embodiment, the recess 27 forms a through-going channel in the spindle 6. In an alternative, not shown embodiment, the recess can be blind bored, i.e. non-through-going, so that the recess exhibits an opening only at one end of the spindle. The spindle 6 comprises an internal thread 7, which is arranged on said limiting surface 34. The thread 7 has a predetermined axial extension l₁, i.e. a predetermined extension in the longitudinal direction of the spindle 6. The thread 7 can extend across only a part of the limiting surface 34, but preferably extends across the entire limiting surface 34. Preferably, the thread 7 extends along at least three-fourths of the full length of the spindle 6, but more preferably the thread 7 extends along the entire length of the spindle 6.

The spindle 6 is preferably made of brass, but can alternatively be made of other materials, e.g. of some kind of polymer.

By means of screw means 10, the spindle 6 is fixedly connected to and coaxially arranged at the worm wheel 4 of the worm gear 3 so that the axial rotation of the spindle 6 is driven by the worm wheel 4. The spindle 6 extends on both sides of the worm wheel 4. At its middle portion, the spindle 6 is rotatably mounted in a bearing 12 which is arranged in a bearing housing 15. The bearing housing 15 is fixedly connected to the gear housing 14.

The piston rod 9 is elongated and extends between a first, inner end 28 and a second, outer end 29. At its inner end 28, the piston rod 9 comprises a threaded portion 11 which exhibits an external thread 30 and has a predetermined axial extension l₃, i.e. a predetermined extension in the longitudinal direction of the piston rod 9, said longitudinal direction coinciding with the longitudinal direction of the spindle 6. The piston rod 9 also comprises a smooth portion 18, which extends from the outer end 29 of the piston rod 9 to the threaded portion 11. The thread 30 of the piston rod 9 is adapted to interact with the internal thread 7 of the spindle 6 in such a way that the rotation of the spindle 6 drives the piston rod 9 to move in a linear translational movement relative to the spindle 6, between a first, inner end position, which is shown in FIG. 3, and a second, outer end position, which is shown in FIG. 4, said end positions defining a length of stroke l₂ of the piston rod 9. The threaded portion 11 should be so designed that it can reliably convert the rotational movement of the spindle 6 into said translational movement of the piston rod 9, while taking into account the torque of the motor 1 and the forces the actuator is subjected to during the translational movement. Provided that these criteria are met, however, the thread 30 should be designed as short as possible.

A first, outer fixing element 19 is arranged at the outer end 29 of the piston rod 9. The fixing element 19 exhibits a through hole 21 which is intended to be used for attaching the first fixing element 19 to a first, not shown, structural element, which first structural element the actuator is intended to adjust relative to a second, not shown, structural element. The attachment of the piston rod 9 to the first structural element prevents a rotation of the piston rod 9 about its own axis when the spindle 6 rotates.

The actuator also comprises a piston tube 8 which extends between a first, inner end 31 and a free, second, outer end 32. At its inner end 31, the piston tube 8 exhibits a flange 33, by means of which the piston tube 8 is fixedly connected to the bearing housing 15. In the axial direction, the piston tube 8 has a length such that it surrounds the outer end 26 of the spindle 6 with its outer end 32. At the outer end 26 of the spindle 6, a bearing 24 is arranged between the spindle 6 and the piston tube 8. An end plate 16 is arranged at the free, outer end 32 of the piston tube 8. The end plate 16 exhibits a circular hole 17 for the piston rod 9. A seal 23 is arranged in the circular hole 17, for sealing against the smooth portion 18 of the piston rod 9.

A bearing 24 is arranged between the outer end 26 of the spindle 6 and the outer end 32 of the piston tube 8, in which bearing 24 the spindle 6 is rotatably mounted. Accordingly, the spindle 6 is rotatably arranged in the actuator by means of the bearing 24, on the one hand, and by means of the previously mentioned bearing 12, on the other hand.

The actuator comprises a second, inner fixing element 20 which is arranged at the gear housing 14. The inner fixing element 20 exhibits a through hole 22 which is intended for attaching the inner fixing element 20 to the previously mentioned second structural element.

According to the invention, the axial extension l₁ of the internal thread 7 of the spindle 6 is longer than the axial extension l₃ of the threaded portion 11 of the piston rod 9. Preferably, the axial extension l₁ of the internal thread 7 of the spindle 6 is at least twice as long, for example 4-5 times as long, as the axial extension l₃ of the threaded portion 11 of the piston rod 9. Furthermore, the axial extension l₁ of the internal thread 7 of the spindle 6 is preferably at least as long as the length of stroke l₂ of the piston rod 9. This implies that the mounting dimensions of the actuator can be made small in relation to the length of stroke of the actuator, which consequently results in an actuator having a small apparatus constant. Furthermore, the design is simple with few component parts, and robust, which implies that the design can handle large loads. Furthermore, the design implies that a large length of stroke can be obtained without exposing the threaded portion 11 of the piston rod outside the spindle 6 during any part of the translational movement of the piston rod, which gives the advantage that grease and/or oil on this portion 11 cannot contaminate the external environment, and also that dirt and contaminants from the external environment cannot deposit on the threaded portion 11 and disturb the translational movement of the piston rod 9. In this context, it is appreciated that an efficient sealing between the seal 23 and the piston rod 9 can be obtained, since the seal 23 acts against the smooth portion 18 of the piston rod 9 and not against its threaded portion 11.

Accordingly, in the actuator according to the invention, the spindle 6 has an axial extension which is substantially larger than the axial extension of a spindle nut in a conventional actuator. The large axial extension of the spindle 6 implies that a large freedom of choice with regard to the position of the motor is allowed. Since the spindle 6 can be designed so that its extends across virtually the entire retracted length of the actuator, an uncomplicated transmission of the torque of the motor to the spindle can be obtained regardless of where the motor is positioned along the actuator.

In the shown embodiment, the length of stroke l₂ of the actuator is substantially equal to the axial extension l₁ of the internal thread 7 of the spindle 6 minus the axial extension l₃ of the threaded portion 11 of the piston rod 9. It is appreciated, however, that if parts of the threaded portion 11 are allowed to project slightly outside the spindle 6 in the inner or the, not shown, outer end position of the piston rod 9, a length of stroke which is longer than the axial extension of the internal thread 7 of the spindle 6 can be obtained. However, such an embodiment implies that there is a risk of oil or grease spreading outside the spindle 6 and a risk of dirt depositing on the exposed part of the threaded portion 11, as has been described above. It shall be noted, however, that such an embodiment is encompassed within the scope of the invention, even though it is less preferred.

In the embodiment which is shown in FIGS. 1-5, where the drive shaft 3 of the motor 1 is substantially orthogonal to the extension of the spindle 6, it is made possible to arrange the worm wheel 4 in an optional position between the inner end 25 of the spindle 6 and the outer end 26 of the spindle. On the one hand, this makes it possible that the design of the actuator, with respect to the position of the motor, is adapted according to requirements and/or field of application and, on the other hand, that the actuator obtains a very small mounting dimension. FIGS. 6 and 7 show an embodiment where the worm wheel 4 is arranged at the middle of the spindle 6.

It is appreciated that the axial rotation of the spindle can be driven in other, not shown ways, e.g. by a disc-rotor motor. The spindle is then fixedly connected to and coaxially arranged at the disc-rotor of the motor, wherein the disc-rotor constitutes the drive shaft of the motor, so that the axial rotation of the spindle is driven by the disc-rotor.

It is also appreciated that a different motor than a DC motor can be used for driving the axial rotation of the spindle, for example an AC motor or a combustion engine with a gear box can be used.

The worm wheel 4 and the disc-rotor above each constitute a drive gear for the spindle, wherein the spindle is fixedly connected to and coaxially arranged at the drive gear in order to be rotated axially by the drive gear.

In the foregoing, the invention has been described based on a specific embodiment. It is appreciated, however, that other embodiments and variants are possible within the scope of the following claims. For instance, it is not necessary that the spindle is driven by the drive shaft of the motor via a worm gear. Naturally, other types of gears and transmissions from the motor to the spindle are possible. Furthermore, the drive shaft could drive the spindle directly, i.e. without using a gear box between the drive shaft and the spindle. In such an embodiment, the drive shaft is arranged linearly with respect to the spindle. Furthermore, the actuator could be provided with a double-acting piston rod, wherein the piston rod extends through the spindle and comprises fixing elements at both of its ends.

1. An actuator comprising:
a motor which comprises a rotatable drive shaft,
a spindle which is rotatably arranged to be driven directly or indirectly by the drive shaft of the motor and which exhibits an axial recess which is at least partially delimited by a substantially circularly cylindrical, internal limiting surface of the spindle, said spindle comprising an internal thread arranged on at least a part of said limiting surface, said thread having a predetermined axial extension, and
a piston rod which is arranged in the recess of the spindle to perform a translational movement in an axial direction relative to the spindle between a first end position and a second end position while the spindle is rotating, said end positions defining a length of stroke of the piston rod, said piston rod comprising a threaded portion which exhibits an external thread and has a predetermined axial extension, said external thread being adapted to interact with the internal thread of the spindle,
characterized in that the axial extension of the internal thread of the spindle is at least twice as long as the axial extension of the threaded portion of the piston rod.

2. The actuator according to claim 1, characterized in that the axial extension of the internal thread of the spindle is at least 4-5 times as long as the axial extension of the threaded portion of the piston rod.

3. The actuator according to claim 1, characterized in that the axial extension of the internal thread of the spindle at least as long as the length of stroke of the piston rod.

4. The actuator according to claim 1, characterized in that the internal thread of the spindle extends along at least three-fourths of the full length of the spindle.

5. The actuator according to claim 1, characterized in that the internal thread of the spindle extends along the entire length of the spindle.

6. The actuator according to claim 1, characterized in that said recess forms a through going channel in the spindle.

7. The actuator according to claim 1, characterized in that the spindle is made of brass.

8. The actuator according to claim 1, characterized in that the actuator comprises a piston tube, which surrounds at least one end of the spindle.

9. The actuator according to claim 1, characterized in that the spindle is fixedly connected to and coaxially arranged at a drive gear to be rotated axially by the drive gear.

10. The actuator according to claim 1, characterized in that, on the one hand, the actuator comprises a worm gear, which comprises a worm driven by the drive shaft of the motor, and a worm wheel driven by the worm, and that, on the other hand, the spindle is fixedly connected to the worm wheel to be driven by the drive shaft of the motor via the worm and the worm wheel.

11. The actuator according to claim 1, characterized in that the drive shaft of the motor is linearly arranged with respect to the spindle to drive the spindle.
